(19) United States
(12) Patent Application Publication
(10) Pub. No.: US 2005/0045581 A1
(43) Pub. Date: Mar. 3, 2005

(54) Method for manufacturing magnetic recording medium

(75) Inventors: Takahiro Suwa, Tokyo (JP); Kazuhiro Hattori, Tokyo (JP); Shuichi Okawa, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/924,803

(22) Filed: Aug. 25, 2004

(30) Foreign Application Priority Data
Aug. 27, 2003 (JP) 2003-303293

(51) Int. Cl. B44C 1/22

(52) U.S. Cl. 216/22

(57) ABSTRACT

A method for manufacturing a magnetic recording medium is provided, by which the magnetic recording medium having a recording layer formed into a predetermined concavo-convex pattern and an adequately flat surface can be efficiently and certainly manufactured. Particles of a non-magnetic material are applied to a member to be processed from a direction relatively inclined with respect to a normal to the surface of the member to be processed. Also, the member to be processed is rotated around a central axis which is inclined with respect to an application direction of the particles of the non-magnetic material, to fill recessed portions of the concavo-convex pattern with the non-magnetic material.

### BACKGROUND OF THE INVENTION

1. Field of the Invention

The present invention relates to a method for manufacturing a magnetic recording medium.

2. Description of the Related Art

Conventionally, in a magnetic recording medium such as a hard disc the areal density thereof has been increased remarkably by various technical improving methods such as,making magnetic particles composing a recording layer finer, changing of materials, sophisticating of a head processing. Further improvement of the areal density is expected in the future.

However, problems such as the limitations of sophisticating of a head processing, a side fringe and crosstalk caused by the extent of a magnetic field have become conspicuous, and the improvement of the areal density by use of conventional improving methods is approaching its limits. Accordingly, a discrete track type magnetic recording medium has been proposed as a candidate for a magnetic recording medium which can realize further improvement of the areal density (for example, refer to Japanese Patent Laid-Open Publication No. Hei 9-97419). In this magnetic recording medium, a recording layer is formed into predetermined concavo-convex pattern and recessed portions of the concavo-convex pattern are filled with a non-magnetic material.

As the processing technique for forming the recording layer into predetermined concavo-convex pattern, a method of dry etching such as reactive ion etching is available (for example, refer to Japanese Patent Laid-Open Publication No. Hei 12-322710).

Processing techniques such as sputtering, which are used in a field of manufacturing a semiconductor, are available as a method for filling with a non-magnetic material. When the processing techniques such as the sputtering are used, the non-magnetic material is deposited on the top face of the recording layer, in addition to the recessed portions of the concavo-convex pattern. Thus, the surface of the non-magnetic material is formed into a concavo-convex shape by copying the concavo-convex pattern of the recording layer.

It is preferable that any surplus non-magnetic material on the recording layer should be removed as much as possible in order to obtain a favorable magnetic property. Since there arise problems of unstable flying of the head and deposition of foreign matters due to steps formed on the surface of the magnetic recording medium, it is preferable to flatten the surfaces of the recording layer and the non-magnetic material. Processing techniques such as CMP (chemical mechanical polishing), which are used in the field of manufacturing a semiconductor, are available for removing the surplus non-magnetic material on the recording layer and for flattening the surfaces of the recording layer and the non-magnetic material.

When the film thickness of the non-magnetic material is thin, however, the recessed portion of the concavo-convex pattern is not completely filled with the non-magnetic material, so that there are cases that the surfaces of the recording layer and the non-magnetic material cannot be flattened sufficiently. Even if the recessed portions of the concavo-convex pattern are completely filled with the non-magnetic material, when the film thickness of the non-magnetic material is thin, the surfaces of the recording layer and the non-magnetic material may not be flattened sufficiently. To be more specific, as shown in FIG. 20A, the surface of a non-magnetic material 102 is formed into a concavo-convex shape by copying a concavo-convex shape of a recording layer 104. On the other hand, the non-magnetic material 102 is flattened with overall removal in a flattening process, and concavo-convex shape in the surface is gradually eliminated. If the film thickness of the non-magnetic material is thin, the flattening process having the effect of eliminating the concavo-convex shape in the surface becomes substantially short. Therefore, as shown in FIG. 20B, even if the non-magnetic material 102 is removed up to the top face of the recording layer 104, the concavo-convex shape in the surface of the non-magnetic material 102 may not be sufficiently eliminated.

In contrast thereto, depositing the non-magnetic material thicker can solve the foregoing problem, but brings another problem that in efficiency in the use of material decreases and manufacturing cost increases. Also, there is a problem that time for the flattening process becomes long, and hence manufacturing efficiency decreases. Furthermore, the film thickness of the deposited non-magnetic material tends to vary in a constant proportion in accordance with areas on the substrate. Thus, when the non-magnetic material is thickly deposited, the distribution of film thickness (variations in film thickness) of the non-magnetic material becomes extensive. This may reduce the effect on flattening the surface by depositing the non-magnetic material thicker. Otherwise, the surface cannot be adequately flattened in the flattening process, and the degree of concavo-convex shape in the surface of the magnetic recording medium may contrarily become larger.

### SUMMARY OF THE INVENTION

In view of the foregoing problems, various exemplary embodiments of this invention provide a method for manufacturing a magnetic recording medium, by which the magnetic recording medium having a recording layer formed into a predetermined minute concavo-convex pattern and an adequately flat surface can be efficiently and certainly manufactured.

According to one exemplary embodiment of this invention, the particles of a non-magnetic material are applied to a member to be processed from a direction relatively inclined with respect to a normal to the surface of the member to be processed. Also, recessed portions of a concavo-convex pattern of a recording layer are filled with the non-magnetic material while relatively varying the posture of the member to be processed with respect to an application direction of the particles of the non-magnetic material. Thus, the degree of concavo-convex shape in the surface of the non-magnetic material, which is deposited while copying the concavo-convex shape of the recording layer, is reduced, so that it is possible to achieve the foregoing object. In other words, since the degree of concavo-convex shape in the surface of the deposited non-magnetic material is small, it is possible to sufficiently flatten the concavo-convex shape in a flattening process, even when the non-magnetic material is thinly deposited. Also, since the non-magnetic material can be thinly deposited, time for the flattening process is shortened, and hence it is possible to improve manufacturing efficiency.

Accordingly, various exemplary embodiments of the invention provide
a method for manufacturing a magnetic recording medium, the magnetic recording medium being made of a member to be processed having a recording layer, the recording layer being formed over a substrate into a predetermined concavo-convex pattern, the method comprising:
a non-magnetic material filling step for applying particles of a non-magnetic material to the member to be processed from a direction relatively inclined with respect to a normal to a surface of the member to be processed to fill recessed portions of the concavo-convex pattern with the non-magnetic material while relatively varying a posture of the member to be processed with respect to an application direction of the particles of the non-magnetic material, and
a flattening step for removing a surplus of the non-magnetic material to flatten the surface of the member to be processed.

In this description, “a recording layer is formed into predetermined concavo-convex pattern over a substrate” means that a recording layer is formed into predetermined patterns over a substrate to be divided into many recording elements, thereby forming the recessed portion between the recording elements. In addition, this also means that the recording layer is partially divided and, for example, spiral recording elements are formed over the substrate, or recording elements in a partially continuous predetermined pattern are formed over the substrate, thereby forming the recessed portion between the recording elements. Furthermore, this also means that both of a projected portion and a recessed portion are formed in the recording layer.

According to one exemplary embodiment of this invention, the particles of the non-magnetic material are applied to the member to be processed from the direction relatively inclined with respect to the normal to the surface of the member to be processed. Also, the recessed portions of the concavo-convex pattern of the recording layer are filled with the non-magnetic material while relatively varying the posture of the member to be processed with respect to the application direction of the particles of the non-magnetic material. Thus, the degree of concavo-convex shape in the surface of the non-magnetic material, which is deposited with copying the concavo-convex shape of the recording layer, is reduced, so that it is possible to sufficiently flatten the concavo-convex shape in the flattening process, even if the non-magnetic material is thinly deposited. Also, a time period for the flattening process can be shortened, because the non-magnetic material is thinly deposited. Thus, it is possible to improve the manufacturing efficiency. Therefore, it is possible to efficiently and certainly manufacture the magnetic recording medium which has the recording layer formed into the concavo-convex pattern and the adequately flat surface.

### BRIEF DESCRIPTION OF THE DRAWINGS

Various exemplary embodiments of the present invention will be described in detail with reference to the accompanying drawings, wherein:

FIG. 1 is a sectional view schematically showing the configuration of a processing start member of a member to be processed according to an embodiment of the present invention;

FIG. 2 is a sectional view schematically showing the configuration of a magnetic recording medium which is obtained by processing the member to be processed;

FIG. 3 is a sectional view schematically showing the configuration of an ion beam deposition device for filling the member to be processed with a non-magnetic material;

FIG. 4 is a flowchart showing an overview of a manufacturing process of the magnetic recording medium;

FIG. 5 is a sectional view schematically showing the shape of the member to be processed, in which a concavo-convex pattern is transferred to a resist layer;

FIG. 6 is a sectional view schematically showing the shape of the member to be processed, in which the resist layer in the bottoms of recessed portions is removed;

FIG. 7 is a sectional view schematically showing the shape of the member to be processed, in which a second mask layer in the bottoms of recessed portions is removed;

FIG. 8 is a sectional view schematically showing the shape of the member to be processed, in which a first mask layer in the bottoms of recessed portions is removed;

FIG. 9 is a sectional view schematically showing the shape of the member to be processed, in which recording elements are formed;

FIG. 10 is a sectional view schematically showing the shape of the member to be processed, in which the mask layer left on the tops of the recording elements is removed;

FIG. 11 is a sectional view schematically showing the shape of the member to be processed, in which a barrier layer is formed on the tops of the recording elements and the recessed portions between the recording elements;

FIGS. 12A and 12B are sectional views schematically showing a process for filling the recessed portions between the recording elements with the non-magnetic material;

FIG. 13 is a sectional view schematically showing the shape of the member to be processed, in which the non-magnetic material is deposited;

FIG. 14 is a sectional view schematically showing the shape of the member to be processed, in which the surfaces of the recording elements and the non-magnetic material are flattened;

FIG. 15 is a graph showing relations between an application angle of the non-magnetic material in a non-magnetic material filling process and a step height in the surface before being flattened, in each of members to be processed according to examples 1 and 2 of the present invention and a comparative example;

FIG. 16 is a photomicrograph showing the sectional shape of the member to be processed according to the example 1, on which the non-magnetic material was deposited with an application angle of 60 degrees;

FIG. 17 is a photomicrograph showing the sectional shape of the member to be processed according to the example 1, on which the non-magnetic material was deposited with an application angle of 30 degrees;

FIG. 18 is a graph showing relations between the application angle of the non-magnetic material in the non-magnetic material filling process and a step height in the surface after being flattened, in each of member to be processed according to the examples 1 to 4 and the comparative example of the present invention and a comparative example;

FIG. 19 is a photomicrograph showing the sectional shape of the member to be processed according to the comparative example after the deposition of the non-magnetic material;

FIG. 20A is a sectional view schematically showing the shape of the conventional deposition of the non-magnetic material; and

FIG. 20B is a sectional view schematically showing the sectional shape of the conventional surfaces of recording elements and the non-magnetic material after being flattened.

### DETAILED DESCRIPTION OF THE PREFERRED EMBODIMENTS

Various exemplary embodiments of this invention will be hereinafter described in detail with reference to the drawings.

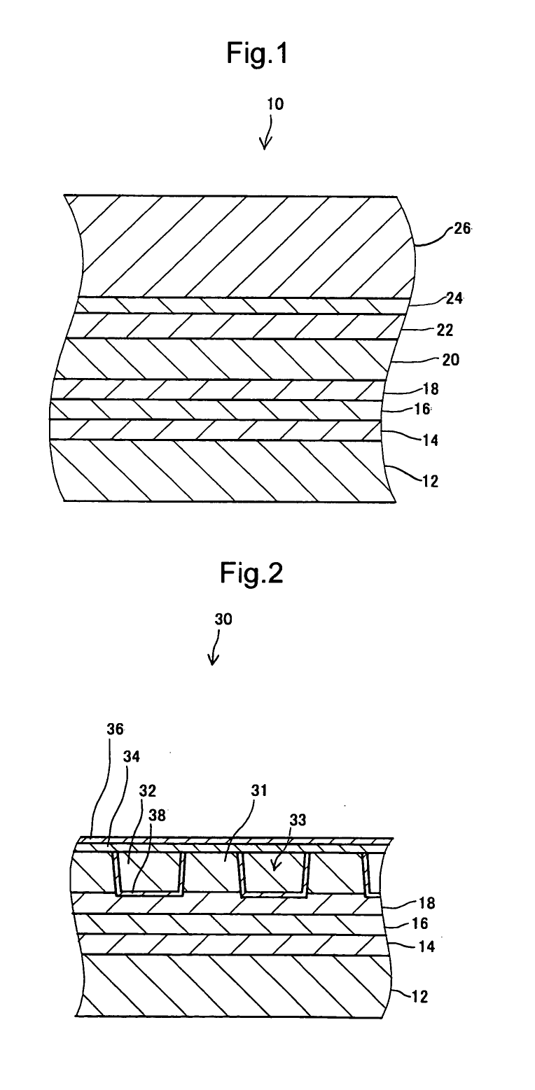

In this exemplary embodiment, a processing start member of a member to be processed as shown in FIG. 1 has a continuous recording layer and the like formed over the surface of a substrate. The processing start member is subjected to processing, so that the continuous recording layer is divided into many recording elements in a predetermined concavo-convex pattern. Recessed portions between the recording elements (recessed portions of the concavo-convex pattern) are filled with a non-magnetic material. As described, this exemplary embodiment relates to a method for manufacturing a magnetic recording medium, by which a magnetic recording medium as shown in FIG. 2 is manufactured, and has characteristics in a non-magnetic material filling process. Since the other processes do not necessarily seem so important to understand this exemplary embodiment, description thereof will be appropriately omitted.

Referring to FIG. 1, the processing start member of the member to be processed 10 includes a underlayer 14, a soft magnetic layer 16, a seed layer 18, a continuous recording layer 20, a first mask layer 22, a second mask layer 24, and a resist layer 26 formed in this order on a glass substrate 12.

The underlayer 14 has a thickness of 30 to 200 nm, and is made of Cr (chromium) or a Cr alloy.

The soft magnetic layer 16 has a thickness of 50 to 300 nm, and is made of a Fe (iron) alloy or a Co (cobalt) alloy.

The seed layer 18 has a thickness of 3 to 30 nm, and is made of CoO, MgO, NiO, or the like.

The continuous recording layer 20 has a thickness of 5 to 30 nm, and is made of a CoCr (cobalt-chromium) alloy.

The first mask layer 22 has a thickness of 3 to 50 nm, and is made of TiN (titanium nitride).

The second mask layer 24 has a thickness of 3 to 30 nm, and is made of Ni (nickel).

The resist layer 26 has a thickness of 30 to 300 nm, and is made of a negative type resist (NBE22A of Sumitomo Chemical Co., Ltd).

As shown in FIG. 2, a magnetic recording medium 30 is magnetic recording disc of a discrete track type on a perpendicular recording system. The continuous recording layer 20 is divided into many recording elements 31 at minute intervals in a radial direction of the track. Recessed portions 33 between the recording elements 31 are filled with a non-magnetic material 32. A protective layer 34 and a lubricating layer 36 are formed in this order over the recording elements 31 and the non-magnetic material 32. A barrier layer 38 is formed between the recording element 31 and the non-magnetic material 32.

The non-magnetic material 32 is made of SiO₂ (silicon dioxide). Both of the protective layer 34 and the barrier layer 38 are made of a hard carbon film called diamond-like carbon, and the lubricating film 36 is made of PFPE (perfluoro polyether). In this description, the term “diamond-like carbon (hereinafter referred to as “DLC”)” designates a material which comprises carbon as a main component with an amorphous structure and has a hardness of approximately 200 to 8000 kgf/mm² in Vickers hardness measurement.

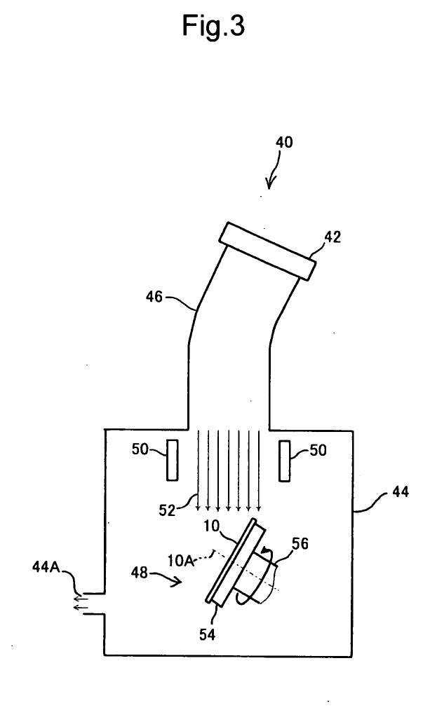

The non-magnetic material 32 is filled by use of an ion beam deposition device as shown in FIG. 3.

The ion beam deposition device 40 comprises an ion emission source 42 for ionizing the particles of SiO₂ (non-magnetic material) by gas discharge, a vacuum chamber 44, a connection tube 46 for connecting the ion emission source 42 to the vacuum chamber 44, a holder mechanism 48 for holding the member to be processed 10 in a predetermined posture in the vacuum chamber 44, and an ion slowing-down mechanism 50 disposed between the connection tube 46 and the holder mechanism 48. The vacuum chamber 44 has an outlet 44A.

The connection tube 46 is bent into the shape of an angle bracket. Ions of the particles of SiO₂ which are separated according to their mass are selectively supplied to the vacuum chamber 44 through the connection tube 46 in a direction approximately vertical with respect to the holder mechanism 48 in the vacuum chamber 44.

The holder mechanism 48 has a jig 54 which holds the member to be processed 10 in such a manner that a normal to the surface of the member to be processed 10 is inclined with respect to the vertical direction. In other words, the ion beam deposition device 40 is configured so as to supply the ions of the particles of SiO₂ to the member to be processed 10 from a direction inclined with respect to the normal to the surface of the member to be processed 10.

The holder mechanism 48 also includes a rotation drive mechanism 56 which rotates the member to be processed 10 together with the jig 54. The rotation drive mechanism 56 is configured so as to rotate the member to be processed 10 around its central axis 10A. In other words, the rotation drive mechanism 56 is configured so as to rotate the member to be processed 10 around the axis which is inclined with respect to an application direction 52 of the particles of SiO₂. The rotation drive mechanism 56 can adjust the angle of the rotational axis. The holder mechanism 48 can adjust a hold angle of the member to be processed 10 with respect to the application direction 52 of the particles of SiO₂.

The ion slowing-down mechanism 50 is configured so as to generate a magnetic field in an application path of an ion beam to slow down the ion beam.

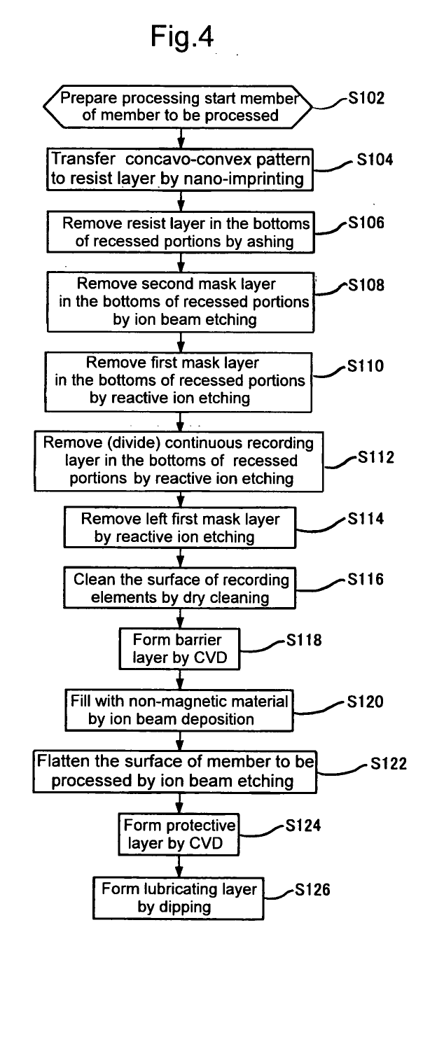

Then, a method for processing the member to be processed 10 will be described along a flowchart shown in FIG. 4.

First, the processing start member of the member to be processed 10 shown in FIG. 1 is prepared (S102). The processing start member of the member to be processed 10 can be obtained by forming the underlayer 14, the soft magnetic layer 16, the seed layer 18, the continuous recording layer 20, the first mask layer 22, and the second mask layer 24 in this order on the glass substrate 12 by a sputtering method, and then applying the resist layer 26 by a dipping method. The resist layer 26 may be applied by a spin coating method.

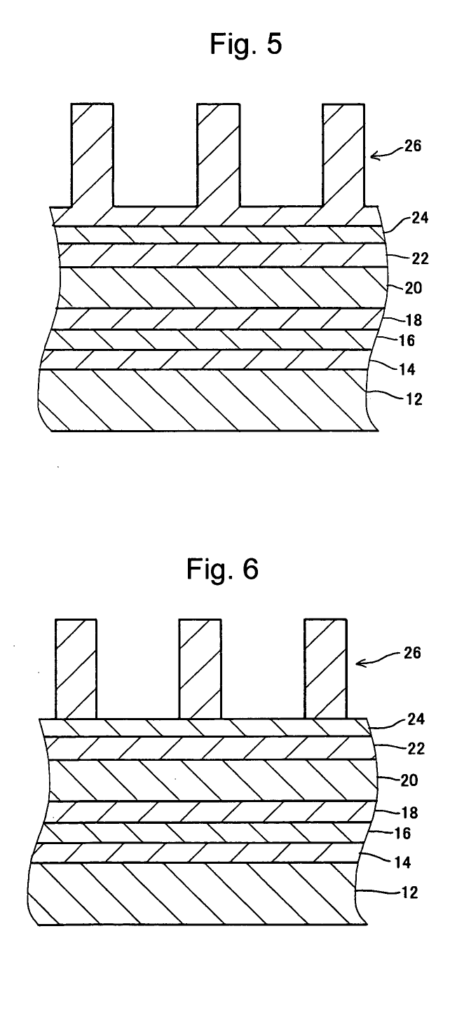

A predetermined servo pattern (not illustrated) including a contact hole, and a concavo-convex pattern as shown in FIG. 5 corresponding to the concavo-convex pattern of the recording elements 31 at minute intervals are transferred to the resist layer 26 of the processing start member of the member to be processed 10 by a nano-imprinting method by use of a transfer device (not illustrated) (S104). Many recessed portions corresponding to a concavo-convex pattern may be formed by exposing and developing the resist layer 26.

Then, as shown in FIG. 6, the resist layer 26 in the bottoms of the recessed portions of the concavo-convex pattern is removed by ashing (S106). At this time, a part of the resist layer 26 in areas except for the recessed portions is removed, but the resist layer 26 in areas except for the recessed portions is left by a difference in height with the bottom face of the recessed portion.

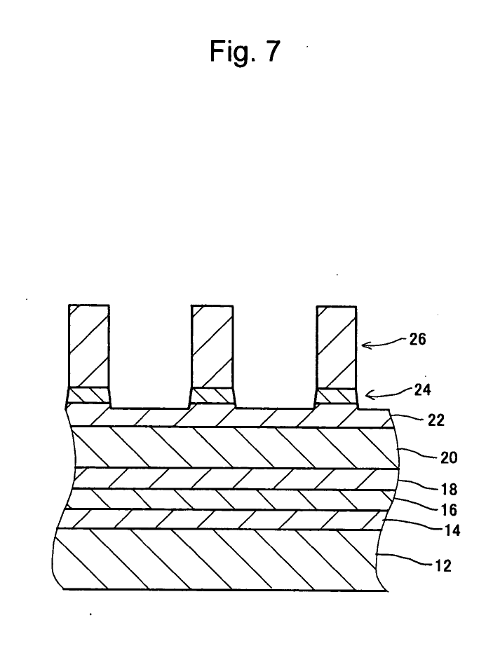

Then, as shown in FIG. 7, the second mask layer 24 in the bottoms of the recessed portions is removed by ion beam etching using an Ar (argon) gas (S108). At this time, a part of the resist layer 26 in the areas except for the recessed portion is removed.

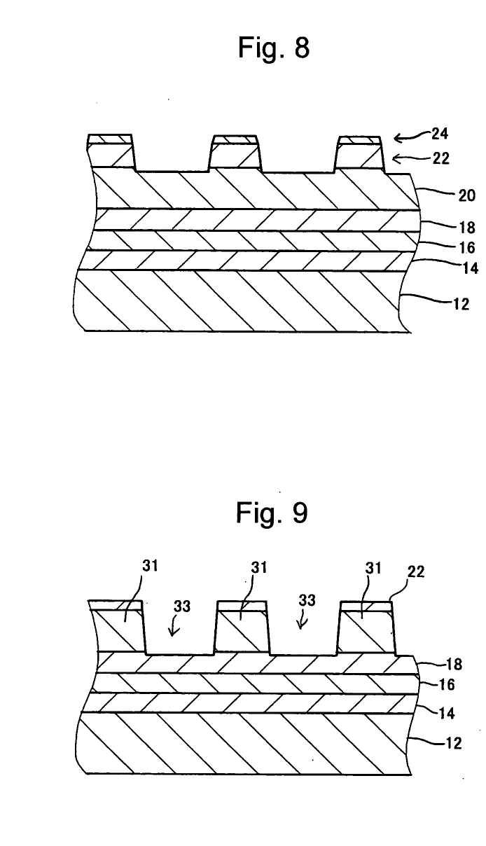

Then, as shown in FIG. 8, the first mask layer 22 in the bottoms of the recessed portions is removed by reactive ion etching using a SF₆ (sulfur hexafluoride) gas (S110). Thus, the continuous recording layer 20 is exposed in the bottoms of the recessed portions. At this time, the resist layer 26 in the areas except for the recessed portions is completely removed. A part of the second mask layer 24 in the areas except for the recessed portions is removed, but a small amount thereof is left.

Then, as shown in FIG. 9, the continuous recording layer 20 in the bottoms of the recessed portions is removed by reactive ion etching using a CO gas and an NH₃ gas as a reactive gas (S112). Thus, the continuous recording layer 20 is divided into the many recording elements 31.

The second mask layer 24 in the areas except for the recessed portions is completely removed by this reactive ion etching. A part of the first mask layer 22 in the areas except for the recessed portions is removed, but a small amount thereof is left on the top faces of the recording elements 31.

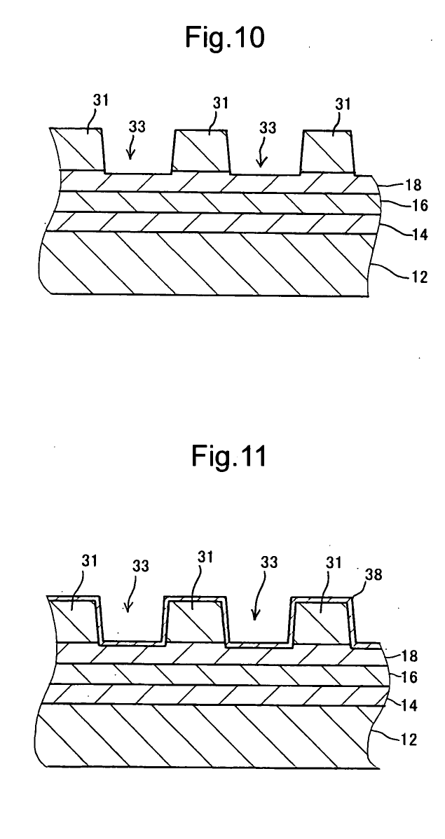

Then, as shown in FIG. 10, the first mask layer 22 remaining on the top faces of the recording elements 31 is completely removed by reactive ion etching using a SF₆ gas as a reactive gas (S114).

Then, the surface of the member to be processed 10 is cleaned (S116). To be more specific, a reduction gas such as an NH₃ gas is supplied to remove the SF₆ gas and the like left on the surface of the member to be processed 10.

Then, as shown in FIG. 11, the barrier layer 38 made of DLC is formed on the recording elements 31 in a thickness of 1 to 20 nm by a CVD method (S118).

Next, the non-magnetic material 32 is deposited by use of the ion beam deposition device 40 in such a manner that the recessed portions 33 between the recording elements 31 are filled with the particles of SiO₂ (S120). The non-magnetic material 32 is deposited so as to completely cover the barrier layer 38.

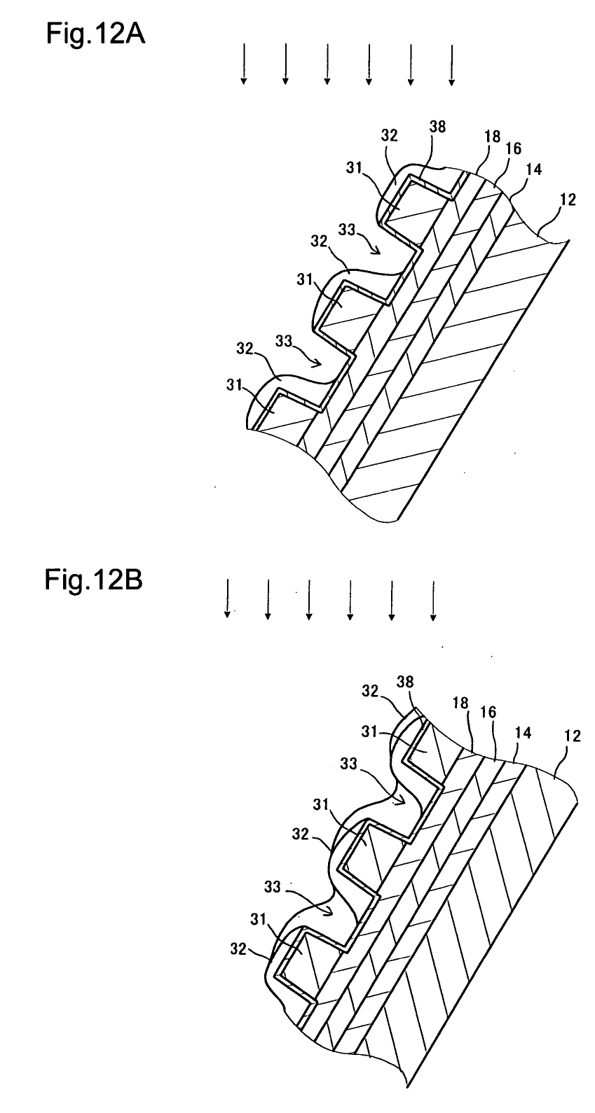

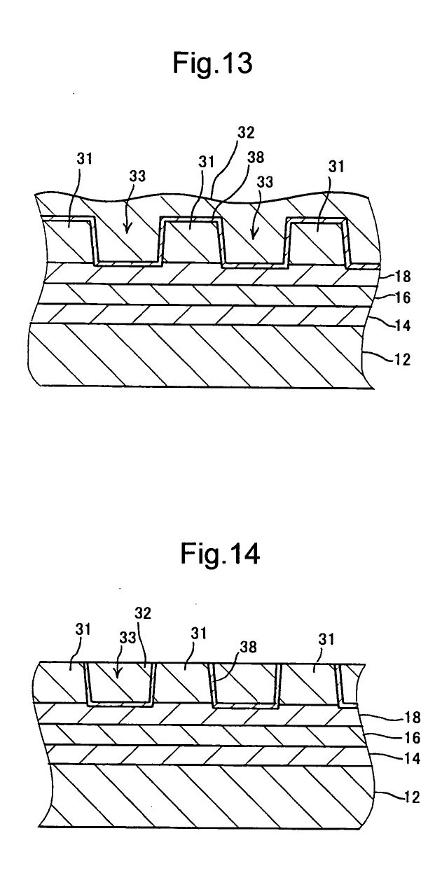

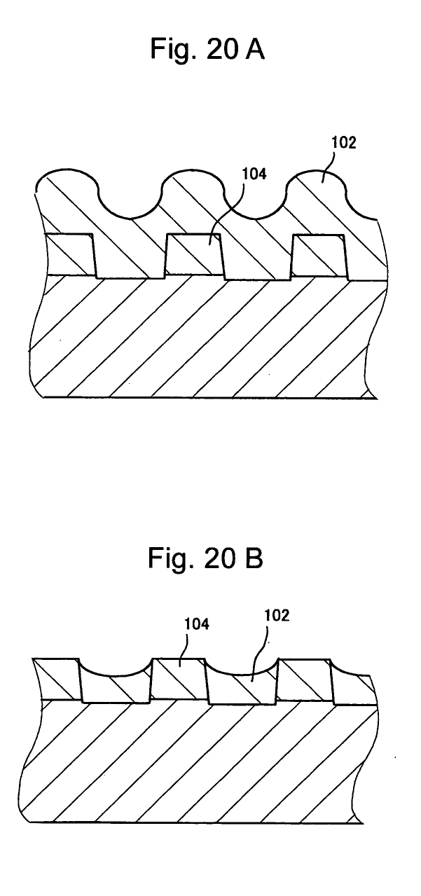

To be more specific, when the jig 54 of the holder mechanism 48 holds the member to be processed 10 and the ion beam emission source 42 supplies the particles of the non-magnetic material 32 to the vacuum chamber 44 through the connection tube 46, the particles of the non-magnetic material 32 adhere to the surface of the member to be processed 10. At this time, the particles of SiO₂ are applied to the member to be processed 10 from the direction inclined with respect to the normal to the surface of the member to be processed 10. Thus, as shown in FIG. 12A, the non-magnetic material 32 is unevenly deposited while copying concavo-convex shape in the surface of the member to be processed 10 for the time being. The rotation drive mechanism 56, however, rotates the member to be processed 10, so that deposition is carried out while relatively varying the posture of the member to be processed 10 with respect to the application direction of the particles of SiO₂. Therefore, as shown in FIG. 12B, concavo-convex shape in the surface of the non-magnetic material 32 is gradually flattened. Variations in the thickness of the deposited non-magnetic material 32, which depend on a position in the glass substrate 12, are also restrained. Accordingly, as shown in FIG. 13, the non-magnetic material 32 is deposited in such a shape that the concavo-convex shape in the surface is restrained and significantly flattened as compared with the conventional shape of deposition as shown in FIG. 20A described above. To express a history of the deposition of the non-magnetic material 32, FIG. 12B schematically shows the non-magnetic material 32 as if the double-layer non-magnetic material 32 is deposited, but the non-magnetic material 32 is integrated actually.

Since the recording elements 31 are covered and protected by the barrier layer 38, the recording elements 31 are not degraded by the ion beam deposition of the non-magnetic material 32.

As described later, the larger an application angle of the particles of SiO₂ with respect to the normal to the surface of the member to be processed 10, the higher the effect of restraining the concavo-convex shape in the surface of the non-magnetic material 32 becomes. Thus, it is preferable that the particles of SiO₂ are applied from a direction inclined 45 degrees or more with respect to the normal to the surface of the member to be processed 10. An upper limit of the application angle is a direction which applies the particles of SiO₂ along the surface of the member to be processed 10, that is, a direction inclined 90 degrees with respect to the normal to the surface of the member to be processed 10.

Then, a surplus of the non-magnetic material 32 on a side farther from the substrate 12 than the top faces of the recording elements 31 (an upper side in FIG. 13) is removed by ion beam etching, in order to flatten the surface of the member to be processed 10 as shown in FIG. 14 (S122). The barrier layer 38 on the top faces of the recording elements 31 may be completely removed, or may be partly left.

The non-magnetic material 32 is deposited in such a shape that the concavo-convex shape in the surface is minutely restrained. Therefore, the concavo-convex shape in the surface of the non-magnetic material 32 is certainly flattened with the overall removal of the non-magnetic material 32 by the ion beam etching.

At this time, it is preferable that an incident angle of Ar ions is set in a range of −10 to 15 degrees with respect to the surface, in order to precisely flatten the surface. If the surfaces of the non-magnetic material 32 are favorably flattened in a non-magnetic material filling process, on the other hand, the incident angle of the Ar ions may be set in a range of 30 to 90 degrees. By doing so, processing speed increases, so that it is possible to increase manufacturing efficiency. “Incident angle” is an angle of the ion beam incident on the surface of the member to be processed, and means an angle which the surface of the member to be processed forms with the central axis of the ion beam. When the central axis of the ion beam is in parallel with the surface of the member to be processed, for example, the incident angle is 0 degree.

Then, the protective layer 34 made of DLC is formed on the top faces of the recording elements 31 and the non-magnetic material 32 in a thickness of 1 to 5 nm by a CVD (chemical vapor deposition) method (S124).

Furthermore, the lubricating layer 36 made of PFPE is formed over the protective layer 34 in a thickness of 1 to 2 nm by a dipping method (S126). Therefore, the magnetic recording medium 30 shown in FIG. 2 is completed.

Since the non-magnetic material 32 is deposited in such a shape as to minutely restrain the concavo-convex shape in the surface, as described above, it is possible to certainly flatten the surfaces of the recording elements 31 and the non-magnetic material 32 even if the non-magnetic material 32 is thinly deposited. Thinly depositing the non-magnetic material 32 can increase efficiency in the use of materials for the non-magnetic material 32, and can also shorten a time period for the flattening process. Therefore, it is possible to increase the manufacturing efficiency.

The non-magnetic material 32 is deposited by the ion beam deposition in this exemplary embodiment. The non-magnetic material may be deposited by another method for deposition such as, for example, sputtering. Also in this case, the particles of the non-magnetic material are applied to the member to be processed from the direction relatively inclined with respect to the normal to the surface of the member to be processed. Also, the member to be processed is relatively rotated around the axis inclined with respect to the application direction of the particles of the non-magnetic material, so that it is possible to minutely restrain concavo-convex shape in the surface of the non-magnetic material.

In this exemplary embodiment, the material for the non-magnetic material 32 is SiO₂. Another non-magnetic material is available, as long as the material is suited for the method for deposition such as the ion beam deposition and the sputtering.

In this exemplary embodiment, the particles of SiO₂ are applied from the direction inclined with respect to the normal to the surface of the member to be processed 10 by means of adjusting the hold angle of the member to be processed 10 by the holder mechanism 48 of the ion beam deposition device 40. A method for application is not especially limited as long as the particles of the non-magnetic material are applied to the member to be processed from a direction relatively inclined with respect to the normal to the surface of the member to be processed. The member to be processed 10, for example, may be horizontally or vertically held at all times, and the particles of the non-magnetic material may be applied from a direction inclined with respect to a horizontal or vertical direction.

In this exemplary embodiment, the member to be processed 10 is rotated around its central axis to evenly apply the particles of the non-magnetic material to the surface of the member to be processed 10. The member to be processed 10 may be rotated around an axis which is also inclined with respect to the normal to the surface of the member to be processed 10, as long as the axis is inclined with respect to the application direction of the particles of the non-magnetic material. Otherwise, the member to be processed 10 may be held in a fixed position, and a mechanism for applying the particles of the non-magnetic material may be rotated with respect to the member to be processed 10.

Furthermore, if the posture of the member to be processed 10 is relatively variable with respect to the application direction of the particles of the non-magnetic material in such a manner that the normal to the surface of the member to be processed is inclined with respect to the application direction of the particles of the non-magnetic material, the particles of the non-magnetic material may be applied to the surface of the member to be processed 10 while moving one or both of the member to be processed 10 and the mechanism for applying the particles of the non-magnetic material by movements except for rotation. In this case, the posture of the member to be processed may be relatively varied with movements by which the normal to the surface temporarily coincides with the application direction of the particles of the non-magnetic material, as long as the non-magnetic material is deposited in such a shape as to minutely restrain the concavo-convex shape in the surface. The member to be processed 10 or the mechanism for applying the particles of the non-magnetic material may be driven by, for example, movements in which a plurality of rotational motions, swinging motions, and the like are combined. Otherwise, the particles of the non-magnetic material may be applied to the surface of the member to be processed 10, while the member to be processed 10 supported by a flexible member irregularly oscillates or swings by use of an eccentric axis or the like. The posture of the member to be processed 10 with respect to the application direction of the particles of the non-magnetic material may be varied continuously or intermittently.

In this exemplary embodiment, the non-magnetic material 32 is removed up to the top faces of the recording elements 31 by the ion beam etching using an argon gas to flatten the surfaces of the member to be processed. The non-magnetic material 32 may be removed up to the top faces of the recording elements 31 by ion beam etching using another noble gas such as Kr (krypton), Xe (xenon), and the like, to flatten the surfaces of the member to be processed 10. The surfaces of the member to be processed 10 may be flattened by reactive ion beam etching using a halogen-containing gas such as SF₆, CF₄ (carbon tetrafluoride), C₂F₆ (hexafluoroethane), and the like. Otherwise, the surfaces of the member to be processed 10 may be flattened by use of a CMP (chemical mechanical polishing) method or an etch back method, by which a resist and the like are applied to make the resist surface flat after the deposition of the non-magnetic material, and then the surplus non-magnetic material is removed up to the recording elements by the ion beam etching method.

In this exemplary embodiment, the first mask layer 22, the second mask layer 24, and the resist layer 26 are formed on the continuous recording layer 20, and then the continuous recording layer 20 is divided by the three steps of dry etching. Materials for the resist layer and the mask layers, the number and thickness of layers, a type of dry etching, and the like are not specifically limited, as long as the continuous recording layer 20 is highly precisely divided.

In this exemplary embodiment, the material for the continuous recording layer 20 (the recording element 31) is a CoCr alloy. The exemplary embodiment of this invention is applicable to the processing of a magnetic recording medium which is composed of recording elements made of another material such as another alloy containing iron group elements (Co, Fe (iron), Ni), a layered product of the alloy and the like.

In this exemplary embodiment, the underlayer 14, the soft magnetic layer 16, and the seed layer 18 are formed under the continuous recording layer 20. The configuration of the layers under the continuous recording layer 20 maybe appropriately changed in accordance with the type of magnetic recording medium. For example, one or two layers of the underlayer 14, the soft magnetic layer 16, and the seed layer 18 may be omitted. Otherwise, the continuous recording layer may be formed directly on the substrate.

In this exemplary embodiment, the magnetic recording medium 30 is of the discrete track type on the perpendicular recording system, in which the recording elements 31 are arranged at minute intervals in the radial direction of the track. The exemplary embodiment of this invention, as a matter of course, is applicable to the manufacture of a magnetic disc in which recording elements are arranged at minute intervals in a peripheral direction (in the direction of a sector) of a track, a magnetic disc in which recording elements are arranged at minute intervals in both of the radial and peripheral directions of a track, a PERM(Pre-Embossed Recording Medium) type magnetic disc having a continuous recording layer in which concavo-convex pattern are formed, and a magnetic disc with a spiral-shaped track. The exemplary embodiment of this invention is applicable to the manufacture of a magneto-optic disc such as a MO and the like, a magnetic disc with thermal assist which concurrently uses magnetism and heat, and another discrete track type of magnetic recording medium in a shape except for a disc such as a magnetic tape and the like.

### EXAMPLE 1

According to the foregoing exemplary embodiment, four members to be processed 10 were processed into a concavo-convex pattern, and a continuous recording layer 20 of each of them was divided into many recording elements 31. In the concavo-convex pattern, as shown in a table 1, a track pitch (the distance between projections of the concavo-convex pattern=the distance between recessed portions) was 300 nm, the width of the recording element was 230 nm, the width of the recessed portion was 70 nm, and a step height (a height of the recording element) was 45 nm.

Then, a layer of SiO₂ was deposited in a thickness of approximately 100 nm while rotating each member to be processed 10 at a rotational speed of approximately 18 rpm by use of the ion beam deposition device 40, to fill the recessed portions-between the recording elements 31 with SiO₂. At this time, each member to be processed 10 was held in such a manner that the application angle of the particles of the non-magnetic material with respect to the normal to the surface of each member to be processed 10 differed in each member to be processed 10. To be more specific, each member to be processed 10 was held in such a manner that the application angle became approximately 15 degrees, 30 degrees, 45 degrees or 60 degrees.

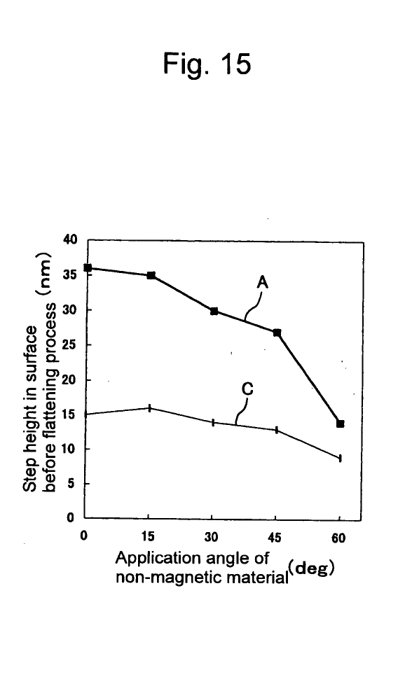

In FIG. 15, a curve with a symbol A indicates relations between the application angle of the particles of the non-magnetic material in the non-magnetic material filling process and an average step height in the surface of the non-magnetic material 32 deposited on each member to be processed 10. In FIG. 15, data on an application angle of 0 (deg) is data on a comparative example described later.

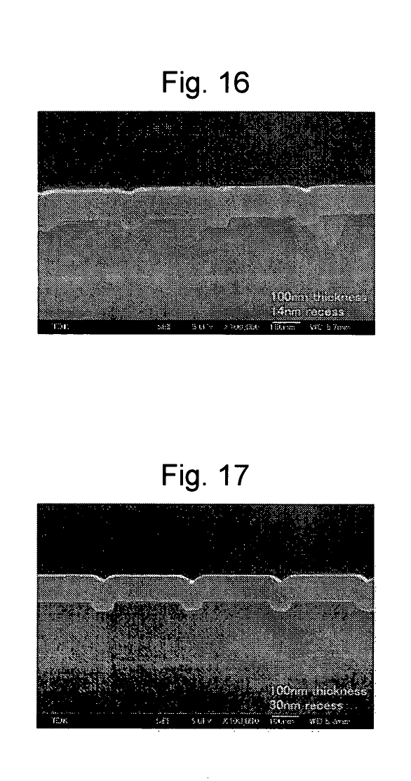

FIG. 16 shows the shape of a section of the member to be processed 10 on which the non-magnetic material 32 was deposited while holding the application angle of the particles of the non-magnetic material at 60 degrees. FIG. 17 shows the shape of a section of the member to be processed 10 on which the non-magnetic material 32 was deposited while holding the application angle of the particles of the non-magnetic material at 30 degrees.

Then, as to the member to be processed 10 on which the non-magnetic material 32 was deposited while holding the application angle of the particles of the non-magnetic material at 60 degrees, arithmetic mean deviation of the surface Ra in the surface of the non-magnetic material 32 was measured. As shown in a table 2, the arithmetic mean deviation of the surface Ra was approximately 1.389 nm.

Then, ion beam etching was carried out for approximately twelve and a half minutes with an incident angle of approximately 2 degrees with respect to the surface of each member to be processed 10, in order to flatten the surface.

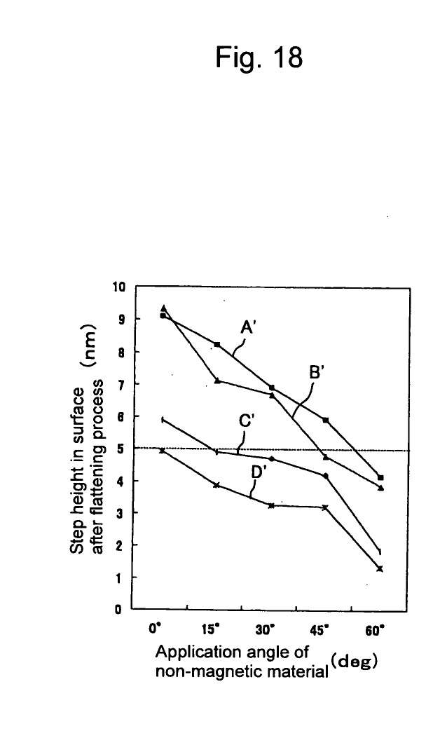

In FIG. 18, a curve with a symbol A′ indicates relations between the application angle of the particles of the non-magnetic material in the non-magnetic material filling process and an average step height in the surface of each member to be processed 10 after the flattening process. In FIG. 18, data on the application angle of 0 (deg) is data on the comparative example described later. Referring to the table 2, arithmetic mean deviation of the surface Ra in the surface of the flattened member to be processed 10, on which the non-magnetic material 32 was deposited while holding the application angle of the particles of the non-magnetic material at 60 degrees, was approximately 0.75 nm.

### EXAMPLE 2

Comparing with the example 1, four members to be processed 10 were processed while changing a concavo-convex pattern as shown in the table 1, and a continuous recording layer 20 thereof was divided into many recording elements 31. In the concavo-convex pattern, the track pitch was 200 nm, the width of the recording element was 150 nm, and the width of a recess portion was 50 nm. The other conditions were the same as those of the example 1.

A curve with a symbol B′ of FIG. 18 indicates relations between the application angle of the particles of the non-magnetic material in the non-magnetic material filling process and an average step height in the flattened surface of each member to be processed 10.

### EXAMPLE 3

Comparing with the examples 1 and 2, four members to be processed 10 were processed while changing the track pitch to 150 nm, the width of the recording element to 110 nm, the width of the recess portion to 40 nm, and the step height to 35 nm. Then, a continuous recording layer 20 was divided into many recording elements 31. The other conditions were the same as those of the example 1.

In FIG. 15, a curve with a symbol C indicates relations between the application angle of the particles of the non-magnetic material in the non-magnetic material filling process and an average step height in the surface of the non-magnetic material 32 deposited on each member to be processed 10.

A curve with a symbol C′ of FIG. 18 indicates relations between the application angle of the particles of the non-magnetic material in the non-magnetic material filling process and an average step height in the flattened surface of each member to be processed 10.

### EXAMPLE 4

Comparing with the examples 1, 2 and 3, four members to be processed 10 were processed while changing the track pitch to 120 nm, the width of the recording element to 90 nm, the width of the recess portion to 30 nm, and the step height to 30 nm. Then, a continuous recording layer 20 was divided into many recording elements 31. The other conditions were the same as those of the example 1.

A curve with a symbol D′ of FIG. 18 indicates relations between the application angle of the particles of the non-magnetic material in the non-magnetic material filling process and an average step height in the flattened surface of each member to be processed 10.

### COMPARATIVE EXAMPLE

As compared with the examples 1 to 4, the application angle of the particles of the non-magnetic material in the non-magnetic material filling process was set to 0 degree. In other words, the particles of the non-magnetic material were applied vertically with respect to the surface of a member to be processed 10. The other conditions were the same as those of the examples 1 to 4.

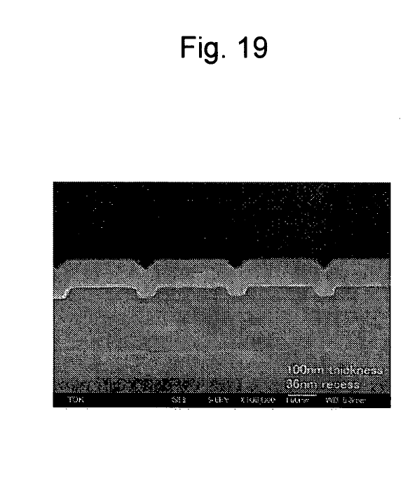

FIG. 19 shows the shape of a section of the member to be processed 10 after the deposition of the non-magnetic material, in which a concavo-convex pattern is the same as that of the example 1. Referring to the table 2, arithmetic mean deviation of the surface Ra in the surface of the deposited non-magnetic material was approximately 2.077 nm. Arithmetic mean deviation of the surface Ra in the flattened surface was approximately 0.936 nm.

Step heights in the-surfaces before the flattening process in cases that concavo-convex pattern are the same as those of the examples 1 and 3 (data on the application angle of 0 (deg)) are shown in FIG. 15. Step heights in the surfaces after the flattening process in cases that concavo-convex pattern are the same as those of the examples 1, 2, 3, and 4 (data on the application angle of 0(deg)) are shown in FIG. 18.

TABLE 1

| | Example 1 | | | |
|---|---|---|---|---|
| | (comparative | | | |
| | example) | Example 2 | Example 3 | Example 4 |
| Track pitch (nm) | 300 | 200 | 150 | 120 |
| Width of recording | 230 | 150 | 110 | 90 |
| element (nm) | | | | |
| Width of recess | 70 | 50 | 40 | 30 |
| (nm) | | | | |
| Step height (nm) | 45 | 45 | 35 | 30 |

TABLE 2
Arithmetic mean deviation of the surface Ra in surface (nm)

| | Example 1 | |
|---|---|---|
| | (application angle | Comparative |
| | of 60 degrees) | example |
| Surface of non-magnetic | 1.389 | 2.077 |
| material before flattening | | |
| process | | |
| Surface of non-magnetic | 0.750 | 0.936 |
| material and recording | | |
| elements after flattening | | |
| process | | |

As shown in the table 2, the surface roughness of the non-magnetic material before the flattening process becomes smaller in the example 1 than in the comparative example. Also, the surface roughness of the non-magnetic material and the recording elements after the flattening process is smaller in the example 1 than in the comparative example. In other words, it is clear that restraining the surface roughness of the non-magnetic material deposited in the non-magnetic material filling process can restrain the surface roughness of the non-magnetic material and the recording elements after the flattening process.

Referring to FIG. 15, it is verified that the larger the application angle of the particles of the non-magnetic material in the non-magnetic material filling process, the smaller the step height in the surface of the deposited non-magnetic material tends to be restrained. Particularly, it is clear that an inclination angle should preferably be set to 45 degrees or more, in order to significantly increase the effect of restraining the step height in the surface of the non-magnetic material. It is clear that the step height in the surface in the example 3 is smaller than that in the example 1, when the inclination angle is equal to each other. This is because the track pitch or the width of the recess portion is smaller in the example 3 than in the example 1.

As shown in FIGS. 16, 17, and 19, it is verified that the width of grooves in the surface of the non-magnetic material 32, which are formed by copying the recessed portions between the recording elements 31, becomes smaller together with the step height in the surface, as the application angle of the particles of the non-magnetic material in the non-magnetic material filling process increases.

Furthermore, it is verified from FIG. 18 that the larger the application angle of the particles of the non-magnetic material in the non-magnetic material filling process, the smaller the step height in the surfaces of the flattened recording elements 31 and non-magnetic material 32 tends to be restrained. When the application angle is equal to one another, the step height in the surfaces becomes small in order of the example 1, 2, 3, and 4. This is because the track pitch or the width of the recessed portion becomes small in order of the example 1, 2, 3, and 4.

In the case of the hard disc, a flying height of a head is 12 nm in general. According to simulation results, it is preferable that the step height in the surface is set to 5 nm or less in order to maintain the favorable flying of the head.

In other words, to maintain the favorable flying of the head by setting the step height in the surface to 5 nm or less, in the example 3 or 4,it is clear that the application angle of the particles of the non-magnetic material in the non-magnetic material filling process should preferably be set to 15 degrees or more. This is because the examples 3 and 4 have the track pitch of 150 nm or less, or the width of the recess portion of 40 nm or less.

In the example 2, it is clear that the application angle of the particles of the non-magnetic material in the non-magnetic material filling process should preferably be set to 45 degrees or more. This is because the track pitch is 200 nm or less, or the width of the recess portion is 50 nm or less in the example 2.

In the example 1, it is clear that the application angle of the particles of the non-magnetic material in the non-magnetic material filling process should preferably be set to 60 degrees or more. This is because the track pitch is 300 nm or less, or the width of the recess portion is 70 nm or less in the example 1.

Various exemplary embodiments of this invention is applicable to the manufacture of a magnetic recording medium having many recording elements such as, for example, a hard disc of discrete track type.

1. A method for manufacturing a magnetic recording medium, the magnetic recording medium being made of a member to be processed having a recording layer, the recording layer being formed over a substrate into a predetermined concavo-convex pattern, the method comprising:
a non-magnetic material filling step for applying particles of a non-magnetic material to the member to be processed from a direction relatively inclined with respect to a normal to a surface of the member to be processed to fill recessed portions of the concavo-convex pattern with the non-magnetic material while relatively varying a posture of the member to be processed with respect to an application direction of the particles of the non-magnetic material, and
a flattening step for removing a surplus of the non-magnetic material to flatten the surface of the member to be processed.

2. The method for manufacturing a magnetic recording medium according to claim 1, wherein
in the non-magnetic material filling step, the recessed portions are filled with the non-magnetic material while relatively rotating the member to be processed around an axis inclined with respect to the application direction of the particles of the non-magnetic material.

3. The method for manufacturing a magnetic recording medium according to claim 1, wherein
in the non-magnetic material filling step, the particles of the non-magnetic material are applied to the surface of the member to be processed by use of one of a sputtering method and an ion beam deposition method.

4. The method for manufacturing a magnetic recording medium according to claim 2, wherein
in the non-magnetic material filling step, the particles of the non-magnetic material are applied to the surface of the member to be processed by use of one of a sputtering method and an ion beam deposition method.

5. The method for manufacturing a magnetic recording medium according to claim 1, wherein
in the non-magnetic material filling step, the particles of the non-magnetic material are applied to the member to be processed from a direction relatively inclined 45 degrees or more with respect to the normal to the surface of the member to be processed.

6. The method for manufacturing a magnetic recording medium according to claim 2, wherein
in the non-magnetic material filling step, the particles of the non-magnetic material are applied to the member to be processed from a direction relatively inclined45 degrees or more with respect to the normal to the surface of the member to be processed.

7. The method for manufacturing a magnetic recording medium according to claim 3, wherein
in the non-magnetic material filling step, the particles of the non-magnetic material are applied to the member to be processed from a direction relatively inclined 45 degrees or more with respect to the normal to the surface of the member to be processed.

8. The method for manufacturing a magnetic recording medium according to claim 4, wherein
in the non-magnetic material filling step, the particles of the non-magnetic material are applied to the member to be processed from a direction relatively inclined 45 degrees or more with respect to the normal to the surface of the member to be processed.

9. The method for manufacturing a magnetic recording medium according to claim 1, wherein
at least some of the recessed portions are formed at intervals of 200 nm or less in the member to be processed, and the particles of the non-magnetic material are applied to the member to be processed from a direction relatively inclined 45 degrees or more with respect to the normal to the surface of the member to be processed in the non-magnetic material filling step.

10. The method for manufacturing a magnetic recording medium according to claim 2, wherein
at least some of the recessed portions are formed at intervals of 200 nm or less in the member to be processed, and the particles of the non-magnetic material are applied to the member to be processed from a direction relatively inclined 45 degrees or more with respect to the normal to the surface of the member to be processed in the non-magnetic material filling step.

11. The method for manufacturing a magnetic recording medium according to claim 3, wherein
at least some of the recessed portions are formed at intervals of 200 nm or less in the member to be processed, and the particles of the non-magnetic material are applied to the member to be processed from a direction relatively inclined 45 degrees or more with respect to the normal to the surface of the member to be processed in the non-magnetic material filling step.

12. The method for manufacturing a magnetic recording medium according to claim 1, wherein
at least some of the recessed portions formed to have a width of 50 nm or less in the member to be processed, and the particles of the non-magnetic material are applied to the member to be processed from a direction relatively inclined 45 degrees or more with respect to the normal to the surface of the member to be processed in the non-magnetic material filling step.

13. The method for manufacturing a magnetic recording medium according to claim 2, wherein
at least some of the recessed portions formed to have a width of 50 nm or less in the member to be processed, and the particles of the non-magnetic material are applied to the member to be processed from a direction relatively inclined 45 degrees or more with respect to the normal to the surface of the member to be processed in the non-magnetic material filling step.

14. The method for manufacturing a magnetic recording medium according to claim 3, wherein
at least some of the recessed portions formed to have a width of 50 nm or less in the member to be processed, and the particles of the non-magnetic material are applied to the member to be processed from a direction relatively inclined 45 degrees or more with respect to the normal to the surface of the member to be processed in the non-magnetic material filling step.

15. The method according to claim 1, wherein
at least some of the recessed portions are formed at intervals of 150 nm or less in the member to be processed, and the particles of the non-magnetic material are applied to the member to be processed from a direction relatively inclined 15 degrees or more with respect to the normal to the surface of the member to be processed in the non-magnetic material filling step.

16. The method according to claim 2, wherein
at least some of the recessed portions are formed at intervals of 150 nm or less in the member to be processed, and the particles of the non-magnetic material are applied to the member to be processed from a direction relatively inclined 15 degrees or more with respect to the normal to the surface of the member to be processed in the non-magnetic material filling step.

17. The method according to claim 3, wherein
at least some of the recessed portions are formed at intervals of 150 nm or less in the member to be processed, and the particles of the non-magnetic material are applied to the member to be processed from a direction relatively inclined 15 degrees or more with respect to the normal to the surface of the member to be processed in the non-magnetic material filling step.

18. The method according to claim 1, wherein
at least some of the recessed portions are formed to have a width of 40 nm or less in the member to be processed, and the particles of the non-magnetic material are applied to the member to be processed from a direction relatively inclined 15 degrees or more with respect to the normal to the surface of the member to be processed in the non-magnetic material filling step.

19. The method according to claim 2, wherein
at least some of the recessed portions are formed to have a width of 40 nm or less in the member to be processed, and the particles of the non-magnetic material are applied to the member to be processed from a direction relatively inclined 15 degrees or more with respect to the normal to the surface of the member to be processed in the non-magnetic material filling step.

20. The method according to claim 3, wherein
at least some of the recessed portions are formed to have a width of 40 nm or less in the member to be processed, and the particles of the non-magnetic material are applied to the member to be processed from a direction relatively inclined 15 degrees or more with respect to the normal to the surface of the member to be processed in the non-magnetic material filling step.
